(19) United States
(12) Patent Application Publication
(10) Pub. No.: US 2025/0020801 A1
(43) Pub. Date: Jan. 16, 2025

(54) Generating Different Data Streams Based on Temporal Relevance

(71) Applicant: AyDeeKay LLC dba Indie Semiconductor, Aliso Viejo, CA (US)

(72) Inventors: David Palmer, Aliso Viejo, CA (US); Setu Mohta, Aliso Viejo, CA (US)

(73) Assignee: AyDeeKay LLC dba Indie Semiconductor, Aliso Viejo, CA (US)

(21) Appl. No.: 18/767,787

(22) Filed: Jul. 9, 2024

Related U.S. Application Data
(60) Provisional application No. 63/526,400, filed on Jul. 12, 2023.

(51) Int. Cl. G01S 13/931

(52) U.S. Cl. CPC G01S 13/931; G01S 2013/932; G01S 2013/9323

(57) ABSTRACT

An integrated circuit that performs multiple separate types of measurements is described. This integrated circuit may include a measurement circuit. Moreover, the integrated circuit may include or may be electrically coupled to at least one sensor. During operation, the integrated circuit may perform the separate types of measurements of or associated with an object in an environment with reduced or obscured information in a visual band of frequencies. For example, the environment with reduced or obscured information may include fog or a cloud. Note that performing of the separate types of measurements may include: filtering measurements based at least in part on velocity relative to ground; and providing data streams having different spatial frequencies and sampling rates based at least in part on the filtering.

### CROSS REFERENCE TO RELATED APPLICATIONS

This application claims priority under 35 U.S.C. 119(e) to U.S. Provisional Application Ser. No. 63/526,400, entitled “Generating Different Data Streams Based on Temporal Relevance,” by David Palmer, et al., filed on Jul. 12, 2023, the contents of which are herein incorporated by reference.

### FIELD

The present disclosure relates to techniques for increasing the amount of information obtained from one or more sensors by using a virtual sensor to generate different data streams.

### BACKGROUND

In order to provide improved safety and more-convenient transportation options, many automotive manufacturers are including additional sensors and/or features in their vehicles. For example, self-driving cars typically include a wide variety of sensors, such as acoustic and/or electromagnetic sensors that monitor the surrounding environment to detect other vehicles, people, animals, or obstacles. However, using multiple sensors (e.g., different types of sensors) typically increases the complexity and the cost of vehicles.

In principle, the cost and the complexity of vehicles can be reduced by eliminating sensors and/or by using a single type of sensor. However, in practice, such streamlining and simplification may result in problems. For example, the performance, and thus, the safety, of a self-driving vehicle may be degraded in corner cases, such as when driving with reduced or obscured vision.

### SUMMARY

Embodiments of an integrated circuit are described. This integrated circuit includes a measurement circuit that performs, using one sensor (and, more generally, a reduced number of sensors), multiple separate types of measurements of or associated with an object in an environment with reduced or obscured information in a visual band of frequencies. However, in other embodiments, the integrated circuit may perform the separate types of measurements in a wide variety of environments.

Notably, the separate types of measurements may include different measurements. Moreover, the separate types of measurements may include time-of-arrival (TOA) measurements.

Furthermore, the separate types of measurements may include radar measurements (such as pulse-echo measurements) and/or LiDAR measurements.

Additionally, the environment with reduced or obscured information may include fog or a cloud (such as a visible mass of condensed water vapor at or near the ground).

In some embodiments, the separate types of measurements may be performed using multiple paths having different path lengths in the sensor and/or the integrated circuit.

Note that the separate types of measurements may provide multiple ways to determine one or more of: a location of the object, motion of the object, size of the object, an angle of incidence of received signals, or a material property of the object (such as reflectivity).

Moreover, the separate types of measurements may include temporally relevant measurements in which spatial measurements have a spatial frequency that is greater than a first predefined value, and temporal measurements have a sampling rate, as a function of time, that is less than a second predefined value.

Alternatively, the separate types of measurements may include spatially relevant measurements in which spatial measurements have a spatial frequency that is less than a third predefined value.

Furthermore, the integrated circuit may provide measurements in the separate types of measurements having a latency that is less than a fourth predefined value before providing second measurements in the separate types of measurements having a latency that is greater than a fifth predefined value.

Note that the separate types of measurements may have a confidence (or a level of certainty that the data is correct) exceeding a sixth predefined value (such as 90, 95 or 99%).

Additionally, the separate types of measurements may correspond to a field of view that is a subset of a scan region of the sensor.

In some embodiments, performing of the separate types of measurements may include: filtering measurements based at least in part on velocity relative to ground; and providing data streams having different spatial frequencies and sampling rates based at least in part on the filtering. For example, the data streams may include a first data stream and a second data stream, where the first data stream has a higher spatial frequency (or resolution) and a lower sampling rate (frame rate) than the second data stream.

Note that the integrated circuit may dynamically adapt the separate types of measurements based at least in part on one or more characteristics of the object (such as a size of the object, speed of the object, visibility of the object in the visual band of frequencies, an angle of incidence of received signals, a material property of the object, e.g., reflectivity, etc.) and/or the presence of the environment.

In some embodiments, the integrated circuit performs the separate types of measurements by executing firmware or software. The integrated circuit may provide a sensor system, which includes a processor and the firmware or software, and includes or is coupled to at least the sensor.

Another embodiment provides an electronic device that includes the integrated circuit. Another embodiment provides a system that includes the integrated circuit.

Another embodiment provides a method for performing the separate types of measurements. This method includes at least some of the operations performed by the integrated circuit.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 is a drawing illustrating an example of a vehicle equipped with radar sensors according to some embodiments of the present disclosure.

FIG. 2 is a block diagram illustrating an example of a driver-assistance system according to some embodiments of the present disclosure.

FIG. 3 is a block diagram illustrating an example of a radar system according to some embodiments of the present disclosure.

FIG. 4 is a block diagram illustrating an example of a radar system according to some embodiments of the present disclosure.

FIG. 5 is a block diagram illustrating an example of operation of a measurement system according to some embodiments of the present disclosure.

FIG. 6 is a drawing illustrating an example of a scan pattern according to some embodiments of the present disclosure.

FIG. 7 is a drawing illustrating an example of a high-resolution scene and a low-resolution scene according to some embodiments of the present disclosure.

FIG. 8 is a flow diagram illustrating an example of a method for performing separate types of measurements according to some embodiments of the present disclosure.

Note that like reference numerals refer to corresponding parts throughout the drawings. Moreover, multiple instances of the same part are designated by a common prefix separated from an instance number by a dash.

### DETAILED DESCRIPTION

An integrated circuit that performs multiple separate types of measurements is described. This integrated circuit may include a measurement circuit. Moreover, the integrated circuit may include or may be electrically coupled to at least one sensor (and, more generally, a reduced number of sensors relative to other integrated circuits that do not use the disclosed analysis techniques). During operation, the integrated circuit may perform the separate types of measurements of or associated with an object, such as in an environment with reduced or obscured information in a visual band of frequencies. For example, the environment with reduced or obscured information may include fog or a cloud. Note that performing of the separate types of measurements may include: filtering measurements based at least in part on velocity relative to ground; and providing data streams having different spatial frequencies and sampling rates based at least in part on the filtering.

By performing the separate types of measurements, these analysis techniques may allow or facilitate improved measurements of the object even when the environment has reduced or obscured information in the visual band of frequencies. Moreover, the analysis techniques may allow the improved measurements (such as improved measurements of a location, motion, size of the object, an angle of incidence of received signals, and/or a material property of the object, e.g., reflectivity) to be performed using fewer and, in some embodiments, at least the one sensor. Consequently, the analysis techniques may reduce the cost and/or the complexity of an electronic device (such as a vehicle) or a system that includes the integrated circuit, while enhancing or improving the performance.

In the discussion that follows, a vehicle may include: an automobile, a sports utility vehicle, a truck, a motorcycle, a train, an aircraft, a boat, or another type of transportation conveyance. However, in the discussion that follows, an automobile is used as an illustrative example of the vehicle.

Moreover, in the discussion that follows, a vehicle may use one or more types of sensors to perform measurements associated with objects in the surrounding environment. While a wide variety of types of sensors may be used, in the discussion that follows radar sensors and/or LiDAR sensors are used as an illustrative example. The radar sensors may perform measurements using at least one of a variety of modes of operation (such as pulsed or continuous-wave), and may involve the use of one or more types of modulation (such as amplitude, frequency and/or phase modulation). In the discussion that follows, frequency-modulated continuous-wave (FMCW) radar is used as an illustration. Furthermore, transmitted and received radar signals (e.g., having carrier frequencies in a radar band of frequencies, such as between 3 MHz and 100 GHz) may be generated and/or processed in the analog domain and/or the digital domain.

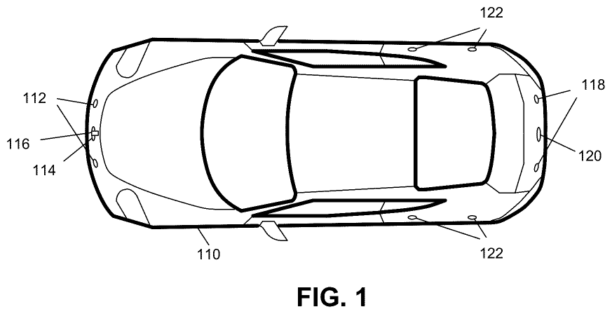

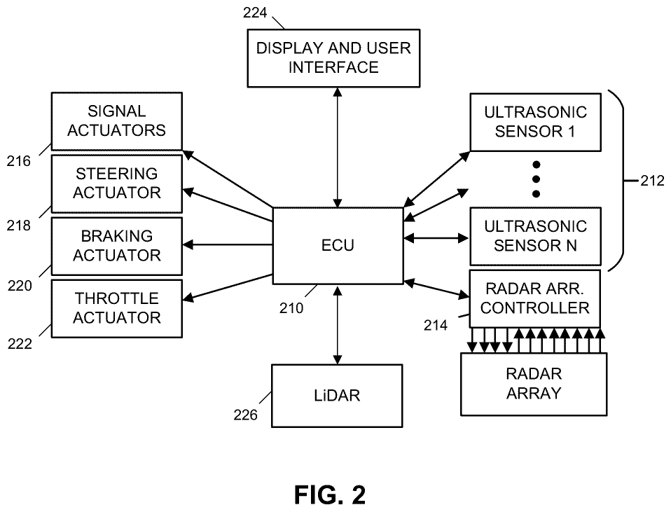

We now describe embodiments of the analysis techniques. FIG. 1 presents a drawing illustrating an example of a vehicle 110 equipped with an array of radar antennas, including: antennas 112 for short-range sensing (e.g., for parking assist), antennas 114 for mid-range sensing (e.g., for monitoring stop-and-go traffic and cut-in events), antennas 116 for long-range sensing (e.g., for adaptive cruise control and collision warning), each of which may be placed behind the front bumper cover. Antennas 118 for short-range sensing (e.g., for back-up assist) and antennas 120 for mid-range sensing (e.g., for rear-collision warning) may be placed behind the back-bumper cover. Moreover, antennas 122 for short-range sensing (e.g., for blind-spot monitoring and side-obstacle detection) may be placed behind the car fenders. Each antenna and each set of antennas may be grouped in one or more arrays. Furthermore, each array may be controlled by a radar-array controller 205 (FIG. 2). In some embodiments, a given set of antennas may perform multiple-input multiple-output (MIMO) radar sensing. The type, number, and configuration of sensors in the sensor arrangement for vehicles having driver-assist and self-driving features varies. The vehicle may employ the sensor arrangement for detecting and measuring distances/directions to objects in the various detection zones to enable the vehicle to navigate while avoiding other vehicles and obstacles. While the preceding discussion illustrates vehicle 110 with radar sensors, in other embodiments vehicle 110 may include one or more different (instead of radar sensors) or one or more additional types of sensors, such as LiDAR, an ultrasonic sensor, a camera, etc.

FIG. 2 presents a block diagram illustrating an example of a driver-assistance system. This driver assistance system may include an electronic control unit (ECU) 210 coupled to various sensors 212, radar-array controller 214 and LiDAR 226 as the center of a star topology. However, other topologies may include serial, parallel, and hierarchical (tree) topologies. Radar-array controller 214 may couple to the transmit and receive antennas (e.g., in antennas 114) to transmit electromagnetic waves, receive reflections, and determine a spatial relationship of the vehicle to its surroundings. Moreover, radar-array controller 214 may couple to carrier-signal generators. In some embodiments, radar-array controller 214 may control the timing and order of actuation of a plurality of carrier signal generators.

In order to provide automated parking assistance, ECU 210 may couple to a set of actuators, such as: a turn-signal actuator 216, a steering actuator 218, a braking actuator 220 and/or a throttle actuator 222. Moreover, ECU 210 may couple to an interactive user interface 224 to accept user input and to display various measurements and system status.

Using user interface 224, sensors, and actuators, ECU 210 may provide: automated parking, assisted parking, lane-change assistance, obstacle and blind-spot detection, autonomous driving and/or other desirable features. During operation of vehicle 110 (FIG. 1), sensor measurements may be acquired by ECU 210, and may be used by ECU 210 to determine a status of vehicle 110. Moreover, ECU 210 may act on the status and incoming information to actuate signaling and control transducers to adjust and maintain operation of vehicle 110. For example, the operations that may be provided by ECU 210 include driver-assist features, such as: automatic parking, lane following, automatic braking, self-driving, etc.

Furthermore, in order to obtain the measurements, ECU 210 may employ a MIMO radar system. Radar systems operate by emitting electromagnetic waves that travel outward from a transmit antenna before being reflected towards a receive antenna. The reflector may be any moderately reflective object in the path of the emitted electromagnetic waves. By measuring the travel time of the electromagnetic waves from the transmit antenna to the reflector and back to the receive antenna, the radar system may determine the distance to the reflector. Additionally, by measuring a Doppler shift of the electromagnetic waves, the radar system may determine a velocity of the reflector relative to vehicle 110 (FIG. 1). When multiple transmit or receive antennas are used, or when multiple measurements are made at different positions, the radar system may determine the direction to the reflector and, thus, may track the location of the reflector relative to vehicle 110 (FIG. 1). With more sophisticated processing, multiple reflectors may be tracked. In some embodiments, the radar system may employ array processing to ‘scan’ a directional beam of electromagnetic waves and to construct an image of the surroundings of environment around vehicle 110 (FIG. 1). In general, pulsed and/or continuous-wave implementations of the radar system may be implemented.

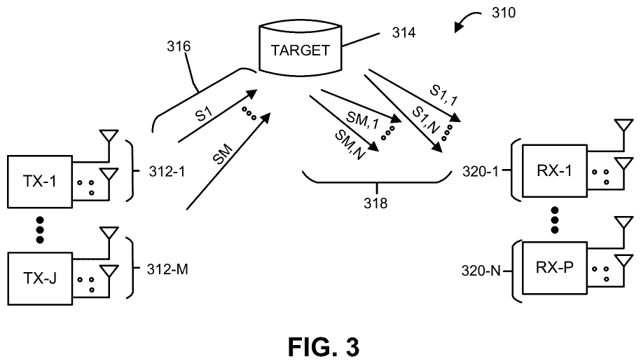

FIG. 3 presents a block diagram illustrating an example of a radar system 310 having a MIMO configuration, in which J transmitters are collectively coupled to M transmit antennas 312 to send transmit signals 316, where J and M are non-zero integers. The M possible transmit signals 316 may reflect from one or more reflectors or targets 314 to be received as receive signals 318 via N receive antennas 320 coupled to P receivers, where N and P are non-zero integers. Each receiver may extract the amplitude and phase or travel delay associated with each of the M transmit signals 316, thereby enabling the system to obtain N.M measurements (though only J·P of the measurements may be obtained concurrently). The processing requirements associated with each receiver extracting J measurements can be reduced via the use of time-division multiplexing and/or orthogonal coding. Moreover, the available antennas may be systematically multiplexed to the available transmitters and receivers to collect the full set of measurements for radar imaging.

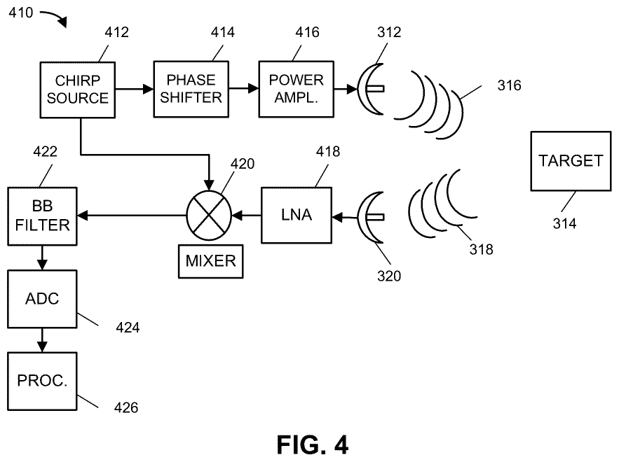

FIG. 4 presents a block diagram illustrating an example of a radar transceiver circuit 410 (e.g., in radar system 310 in FIG. 3). In some embodiments, radar transceiver circuit 410 is implemented as an integrated circuit in a packaged chip. Radar transceiver circuit 410 may include: a carrier-signal (chirp) generator 412, a phase shifter 414, an amplifier 416, and/or transmit antennas 312 which can transmit signals 316 based at least in part on the output of the carrier-signal generator 412. Moreover, radar transceiver circuit 410 may include: receiver antennas 320, a low-noise amplifier (LNA) 418, and/or a mixer 420. Mixer 420 may mix received signals 318 detected by receive antennas 312 with the signal from the carrier-signal generator 412. Furthermore, low-noise amplifier 418 may be used to amplify received signals 318 detected by receive antennas 320. In some embodiments, radar transceiver circuit 410 may include: a sensitivity time controller and equalizer (not shown), a broadband (BB) filter 422, an analog-to-digital converter (ADC) 424 and/or a processor 426 (e.g., ECU 210 and/or radar-array controller 214 in FIG. 2), which may perform further processing of the received signals (such as a Fourier transform). In some embodiments, processor 426 and low-noise amplifier 418 may be coupled for bi-directional communication.

Additionally, in some embodiments, carrier-signal generator 412 may be coupled to radar array-controller 214 (FIG. 2). Carrier-signal generator 412 may include a chirp generator to create an FMCW signal. The chip rate of carrier-signal generator 412 may be controlled by radar-array controller 214 (FIG. 2). In some embodiments, carrier-signal generator 412 may be deactivated by radar-array controller 214 (FIG. 2) to provide an unmodulated carrier signal. Moreover, carrier-signal generator 412 may be implemented as a local oscillation (LO) signal generator, a fractional-N phase lock loop (PLL) with a 24 controller, or as a direct-digital synthesis generator.

Furthermore, carrier-signal generator 412 may be coupled to transmit antennas 312 through phase shifter 414 and amplifier 416. Carrier-signal generator 412 may be coupled to receiving antennas 312 through mixer 420 and low-noise amplifier 418. Additionally, carrier-signal generator 412 may generate a transmit signal (e.g., a chirp signal). Amplifier 416 may receive the transmit signal from carrier-signal generator 412 and transmit signals 316 corresponding to the transmit signal from carrier-signal generator 412 may be transmitted using transmit antennas 312.

In some embodiments, a radar transmitter may include: a phase rotator, a bi-phase modulator, a variable gain amplifier, a switch, a power amplifier driver, a power amplifier, and/or a digital signal processor (DSP). Moreover, in some embodiments, a radar transmitter may include a digital controller. This digital controller may be included in the DSP or may be a separate component. Furthermore, the phase rotator may be used for digital phase modulation. Additionally, the radar transmitter may use a wave-modulated power amplifier in a digital-envelope modulation technique.

As noted previously, it can be difficult to accurate detect one or more objects in some environments, such as an environment with fog or clouds. Moreover, detection of the one or more objects may be expensive and/or complicated. In the discussion that follows, LiDAR is used as an illustrative example in the analysis techniques.

In the disclosed analysis techniques, separate types of measurements may be performed using at least one sensor. The resulting scene (or a scan of the environment) may selectively have high resolution and/or may selectively have a high frame rate, thereby allowing one or more objects (and/or one or more characteristics of the one or more objects) in the environment to be accurately detected or determined.

For example, for LiDAR, a high-resolution scan may have 0.05° per pixel and/or 300,000 pixels per image. Alternatively, a low-resolution scan may have 0.3° per pixel and/or 50,000 pixels per image. Moreover, a high frame-rate scan may have 20 frames per second, while a low frame-rate scan may have 7 frames per second.

Note that point-cloud sensors generally consume ‘frames’ that represent a set of points representing points on the surface of one or more objects in a 3-dimensional (3D) space with a consistent physical relationship at a single moment in time. When used with an off-the-shelf perception engine, the density of points that can be measured by a single sensor, and the timeliness of delivery of those points, may be limited by point-calculation throughput of the sensor, the required field of view, and the temporal stability of the most volatile points (e.g., in a cloud-based computer system that may be used to perform calculations). Therefore, a sensor may trade-off between the timeliness and smoothness of information provided to higher-layer processing (e.g., by the cloud-based computer system) and the density.

In order to address these problems, at least a single sensor (or an integrated circuit or an electronic device that performs measurements) may act as two or more ‘virtual’ sensors, each producing an independent data stream. The information contained in each of these data streams may be carefully constructed so that they are physically and temporally consistent with each other for the maximum amount of time. The careful construction of these data streams may require information that is only present in at least the sensor and may not be part of the upstream perception engine, such as a pretrained artificial neural network, which may be implemented in the electronic device that includes at least the single sensor and/or the cloud-based computer system. (Therefore, in general, the analysis techniques may be implemented locally, such as in an electronic device, e.g., a vehicle, and/or remotely, such as in the electronic device that communicates with a cloud-based computer system, which may implement at least a portion of the processing.)

Note that in some embodiments, the sensor may produce independent data streams. However, in other embodiments, the sensor may output a single data stream that can be filtered and/or sampled in a way to generate the two different streams. In these embodiments, the two data streams may include highly correlated data (because the data streams may be derived from a common signal). The output data stream from or associated with a sensor may represent more ‘raw’ and/or more ‘processed’ data, even if the originating measurement process (e.g., sending a modulated laser and receiving reflected light) is common. Consequently, packets within a class may be prioritized relative to each other, and also different packet classes may be prioritized relative to each other. For example, if some points have been detected at a relatively short range and high speed, then the opinion of the sensor of what type of object or feature they are may not be as relevant. Instead, the sensor may just forward the data to a processor, therefore, reducing the sensor latency may be a high priority. More generally, the sensor may be analogous to a server and the upstream host may be analogous to a client. In automotive systems, there is typically only one client (e.g., a domain controller or central computer). However, this may or may not be the case in other systems. When there is more than one client, the same information may be broadcast everywhere or may be more specific to the needs of a particular client (or even anticipated needs). This typically also results in prioritization among clients.

In this way, a single sensor may provide both high frame rate and high point density to a perception engine, without increasing the hardware or software requirements of the sensor itself.

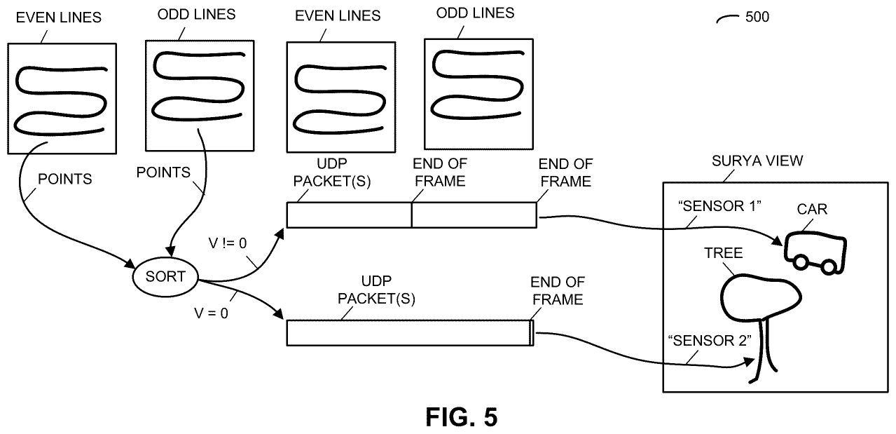

FIG. 5 presents a block diagram illustrating an example of operation of a measurement system 500. In measurement system 500, X is the number of horizontal lines per scanner pass (e.g., 16), N is the number of interleaved scanner passes (e.g., 4), Vth is the velocity magnitude threshold (e.g., 0.1 m/s), FPSlow is the number of end-of-frame markers per second in a low-resolution data stream (which may have a value of N·FPSlow), FPShi is the number of end-of-frame markers per second in a high-resolution data stream (e.g., 1) and PPS is the sum of points per second in both the high and low-resolution data streams (e.g., 500,000). Moreover, in measurement system 500, an integrated circuit in an electronic device (such as a vehicle) may perform LiDAR measurements with odd and even scan lines using virtual sensors (such as a high-resolution and a low-resolution sensor). Furthermore, the integrated circuit may output corresponding high-resolution and low-resolution data streams in a frame using data packets (such as data packets having a User Datagram Protocol or UDP format).

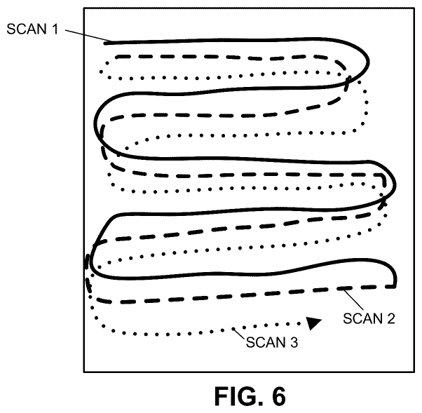

In general, for LiDAR, the scan pattern may be a zig-zag pattern of X horizontal lines. As shown in FIG. 6, which presents a drawing illustrating an example of a scan pattern, each time X lines are scanned, the scanner may change the vertical direction and add a vertical offset. Note that, in contrast with a camera, all the pixels may not be acquired at the same time in a scan. Instead, the pixels may be spread out in time while a frame is acquired during a scan.

Moreover, in the disclosed analysis techniques, sorting or filtering may be performed. Notably, for a non-moving vehicle, points may be sorted based at least in part on velocity measured, e.g., directly from Doppler shift. Points with a component of the radial velocity in the direction of vehicle at (or near, e.g., within 1% of) zero may not have lateral velocity and may be close to the speed of the vehicle, and may be reported in the high-resolution data stream. Alternatively, points with a non-zero velocity may be moving and may be reported in the low-resolution data stream.

(Note that the component of the radial velocity close to the speed of the vehicle may be calculated, because the angle of the scanning and the vehicle motion are known. Moreover, the ‘radial velocity’ vector may be along the line joining the sensor origin to the target. This line may not necessarily be aligned with the motion vector of the vehicle (such as in the case of a sideways facing LiDAR), such as because of a small static origin difference between the sensor and the vehicle.)

In a system (such as the integrated circuit and at least the one sensor) installed on a vehicle in motion, radial velocity may be adjusted by the tangent of the measured azimuth angle to the point and the speed of vehicle motion, such that movement may be relative to the ground and not at least the one sensor. Note that the vehicle speed of motion may be estimated from: vehicle network data (such as a cellular-telephone data network), the Global Positioning System (GPS), and/or by statistical analysis of the point data.

In some embodiments, measurements may be sorted or filtered based at least in part on temporal relevance. For example, measurements having the same velocity as the vehicle may be included in a first data stream having a high spatial frequency and a lower frame rate. This may avoid aggregating measurements that were acquired at disparate times that are not temporally coherent. In contrast, a second data stream with measurements that are not temporally relevant may have a lower spatial resolution and a higher frame rate. The measurements in the second data stream may be spatially sparse, but temporally packed or dense in time.

Note that the sorting or filtering policy may be defined and implemented on at least the sensor and/or the integrated circuit.

In the disclosed analysis techniques, the system may perform sorting or filtering to improve the timeliness of delivery, e.g., points that are spatially proximate or close, have a low time-to-collision, and/or are in the movement path of the vehicle. For example, output steams in the analysis techniques are illustrated in Table 1.

TABLE 1

| | High-Resolution | Low-Resolution |
|---|---|---|
| | Data Stream | Data Stream |
| Stream Name | (HIRES) | (LOWRES) |
| UDP format | C1 | C1 |
| UDP Port | 2370 | 2368 |
| Velocity Filter | \|V\| < Vth | \|V\| > Vth |
| End-of-Frame | Every N · X Lines | Every X Lines |

In some embodiments, the system (e.g., in the integrated circuit in the electronic device, such as a vehicle) may have a visualizer configuration in which multiple virtual sensors may be enabled in a sensor configuration (e.g., two virtual sensors may be enabled, one to port 2370 and the other to port 2368). The sensor corresponding to high resolution may color points based at least in part on range (which is sometimes referred to as ‘range coloring’), and the sensor corresponding to low resolution may color points based at least in part on velocity (which is sometimes referred to as ‘velocity coloring’).

The integrated circuit may build scenes of one or more objections in an environment around or proximate to a vehicle that includes the integrated circuit. Notably, the scenes may correspond to the high-resolution data stream and the low-resolution data stream. These two scenes may be built concurrently or simultaneously by the integrated circuit. Moreover, the network (such as a communication network between the electronic device or vehicle and a cloud-based computer system) may prioritize packets that are part of the low-resolution data stream for reduced or minimum latency.

In some embodiments, the scope of prioritization may be wider than a sorting policy on point cloud attributes. This is because sensors (including LiDAR) typically produce qualitatively different classes of packets. For example, there may be at least five packet classes, including: point cloud data (the aforementioned sorting policy may apply to some combination of attributes at the point level, which is sometimes referred to as the ‘detection level’); feature level data (such as edges or even just clumps of adjacent points without full semantic meaning); object level data (e.g., a road surface, an object on road, etc.); telemetry or sensor health data (e.g., information about sensor temperature, scanner mechanical properties, and/or other self-checks); and/or response packets to field-of-view modification from an upstream host. Note that the sorting policy may use one or a combination of the attributes contained in the packet class. Notably, the sorting policy may (sometimes or always) prioritize: point cloud data within a certain spatial extent of the detected road surface (which, for a curved road, may not always be the center of the field of view); sending point cloud data in a region where a cluster of spatially adjacent points above the road surface has been detected because this can require higher priority analysis by an upstream host, e.g., as to whether it is an obstruction that can be ‘driven over; without necessarily braking (this prioritization may be based at least in part on unsupervised analysis, such as k-means clustering, density based spatial clustering or DBSCAN, etc.); data of type 1, 2 or 3 withing the updated field of view in the response to a field-of-view modification packet type 5; and/or may occur based at least in part on data of type 1, 2 or 3 withing the updated field of view in the response to a field-of-view modification packet type 5 when the sensor detects that it has adequate performance only within a smaller or a subset of an operating region because of a ‘walking wounded’ type of failure.

Note that if the two data-stream velocity filters are mutually exclusive, the analysis techniques may not require additional processor overhead and/or additional UDP traffic overhead. The analysis techniques may require approximately 1.5 kB of additional memory (such as SRAM memory). However, if the velocity filters are not mutually exclusive, then more system resources may be required.

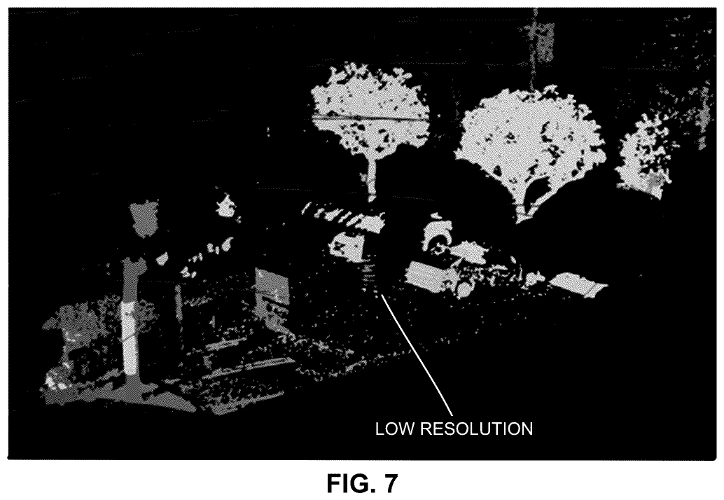

In an exemplary use cases, two upstream perception engines (which may be implemented locally and/or in the cloud), which use different scan-system properties, may be serviced by at least one sensor and one scanning system. Using at least the one sensor, the scanning system may behave as two virtual sensors, each of which may have the properties associated with its respective processing system. FIG. 7 presents a drawing illustrating an example of a high-resolution scene and a low-resolution scene.

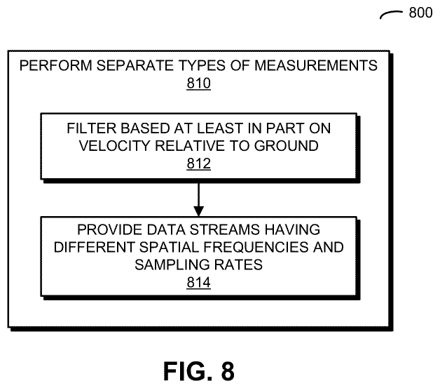

We now describe embodiments of a method. FIG. 8 presents a flow diagram illustrating an example of a method 800 for performing separate types of measurements, which may be performed by an integrated circuit and/or an electronic device. During operation, the integrated circuit may perform the separate types of measurements (operation 810) of or associated with an object in an environment with reduced or obscured information in a visual band of frequencies. Note that the performing of the separate types of measurements (operation 810) may include: filtering measurements (operation 812) based at least in part on velocity relative to ground; and providing, based at least in part on the filtering, data streams having different spatial frequencies and sampling rates (operation 814).

In some embodiments of method 800, there may be additional or fewer operations. Moreover, the order of the operations may be changed, and/or two or more operations may be combined into a single operation.

The disclosed integrated circuit and the analysis techniques can be (or can be included in) any electronic device or system. For example, the electronic device may include: a cellular telephone or a smartphone, a tablet computer, a laptop computer, a notebook computer, a personal or desktop computer, a netbook computer, a media player device, an electronic book device, a MiFi® device, a smartwatch, a wearable computing device, a portable computing device, a consumer-electronic device, an access point, a router, a switch, communication equipment, test equipment, a vehicle, a ship, an airplane, a car, a truck, a bus, a motorcycle, manufacturing equipment, farm equipment, construction equipment, or another type of electronic device.

Although specific components are used to describe the embodiments of the integrated circuit and/or the integrated circuit that includes the integrated circuit, in alternative embodiments different components and/or subsystems may be present in the integrated circuit and/or the integrated circuit that includes the integrated circuit. Thus, the embodiments of the integrated circuit and/or the integrated circuit that includes the integrated circuit may include fewer components, additional components, different components, two or more components may be combined into a single component, a single component may be separated into two or more components, one or more positions of one or more components may be changed, and/or there may be different types of components.

Moreover, the circuits and components in the embodiments of the integrated circuit and/or the integrated circuit that includes the integrated circuit may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar. Note that electrical coupling or connections in the preceding embodiments may be direct or indirect. In the preceding embodiments, a single line corresponding to a route may indicate one or more single lines or routes.

As noted previously, an integrated circuit and/or an electronic device may implement some or all of the functionality of the analysis techniques. This integrated circuit and/or an electronic device may include hardware and/or software mechanisms that are used for implementing functionality associated with the analysis techniques.

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the analysis techniques may be implemented using program instructions that are executed by a processor or in firmware in the integrated circuit and/or another integrated circuit (such as a graphics processing unit or GPU).

Moreover, while examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An integrated circuit, comprising:
a measurement circuit configured to electrically couple to at least one sensor and to perform multiple separate types of measurements of or associated with an object in an environment with reduced or obscured information in a visual band of frequencies.

2. The integrated circuit of claim 1, wherein the separate types of measurements comprise different measurements.

3. The integrated circuit of claim 1, wherein the separate types of measurements comprise time-of-arrival (TOA) measurements.

4. The integrated circuit of claim 1, wherein the separate types of measurements comprise radar measurements, or LiDAR measurements.

5. The integrated circuit of claim 1, wherein the environment with reduced or obscured information comprises fog or a cloud.

6. The integrated circuit of claim 1, wherein the separate types of measurements are performed using multiple paths having different path lengths in at least the one sensor or the integrated circuit.

7. The integrated circuit of claim 1, wherein the performing of the separate types of measurements comprises:
filtering measurements based at least in part on velocity relative to ground; and
providing, based at least in part on the filtering, data streams having different spatial frequencies and sampling rates.

8. The integrated circuit of claim 7, wherein the data streams include a first data stream and a second data stream; and
wherein the first data stream has a higher spatial frequency and a lower sampling rate than the second data stream.

9. The integrated circuit of claim 1, wherein the separate types of measurements comprise temporally relevant measurements in which spatial measurements have a spatial frequency that is greater than a first predefined value, and temporal measurements have a sampling rate, as a function of time, that is less than a second predefined value.

10. The integrated circuit of claim 1, wherein the separate types of measurements comprise spatially relevant measurements in which spatial measurements have a spatial frequency that is less than a predefined value.

11. The integrated circuit of claim 1, wherein the integrated circuit is configured to provide measurements in the separate types of measurements having a latency that is less than a predefined value before providing second measurements in the separate types of measurements having a latency that is greater than a second predefined value.

12. The integrated circuit of claim 1, wherein the separate types of measurements correspond to a field of view that is a subset of a scan region of at least the one sensor.

13. The integrated circuit of claim 1, wherein the integrated circuit is configured to dynamically adapt the separate types of measurements based at least in part on one or more characteristics of the object, a presence of the environment, or both.

14. An electronic device, comprising:
an integrated circuit, wherein the integrated circuit comprises a measurement circuit configured to electrically couple to at least one sensor and to perform multiple separate types of measurements of or associated with an object in an environment with reduced or obscured information in a visual band of frequencies.

15. The electronic device of claim 14, wherein the separate types of measurements comprise time-of-arrival (TOA) measurements.

16. The electronic device of claim 14, wherein the separate types of measurements are performed using multiple paths having different path lengths in at least the one sensor or the integrated circuit.

17. The electronic device of claim 14, wherein the performing of the separate types of measurements comprises:
filtering measurements based at least in part on velocity relative to ground; and
providing, based at least in part on the filtering, data streams having different spatial frequencies and sampling rates.

18. The electronic device of claim 14, wherein the electronic device is configured to dynamically adapt the separate types of measurements based at least in part on one or more characteristics of the object, a presence of the environment, or both.

19. A method for performing separate types of measurements, comprising:
by an electronic device that comprises or is electrically coupled to at least one sensor:
performing the separate types of measurements of or associated with an object in an environment with reduced or obscured information in a visual band of frequencies, wherein the performing of the separate types of measurements comprises:
filtering measurements based at least in part on velocity relative to ground; and
providing, based at least in part on the filtering, data streams having different spatial frequencies and sampling rates.

20. The method of claim 18, wherein the separate types of measurements comprise radar measurements, or LiDAR measurements.
